(19) United States
(12) Patent Application Publication
(10) Pub. No.: US 2003/0089786 A1
(43) Pub. Date: May 15, 2003

(54) Secure real time writing for volatile storage

(76) Inventors: Laurence Bringer, St. Savournin (FR); Pascal Guterman, Roquevaire (FR)

Correspondence Address: BURNS DOANE SWECKER & MATHIS L L P, POST OFFICE BOX 1404, ALEXANDRIA, VA, 22313-1404, US

(21) Appl. No.: 10/203,284

(22) PCT Filed: Feb. 2, 2001
(86) PCT No.: PCT/FR01/00325

(30) Foreign Application Priority Data
Feb. 11, 2000 (FR) 00/01869

(51) Int. Cl. G06K 19/06

(52) U.S. Cl. 235/492

(57) ABSTRACT

Data in a write request (RE1) transmitted by a processor (PR) to a read/write controller (CM) must be written in a non-volatile memory (MNV) in a portable electronic object, such as a smart card. An application can be executed in the processor simultaneously with the writing of the data in the memory in response to an acknowledgement (AC) indicating the availability of the controller for writing. However, another write request transmitted before the end of the writing is put on standby until the end of the writing. The controller also provides a verification of integrity of the data to be written in the memory.

The present invention relates to potentially any smart card, or any equivalent portable electronic object, having a non-volatile memory, for example an electrically erasable programmable memory EEPROM or a FLASH memory.

Smart cards, also referred to as integrated circuit cards or microcontroller cards, like the majority of equivalent portable electronic objects, such as pocket calculators, organisers, electronic purses, electronic games, radiotelephone terminals, remote controls etc, store different types of information in non-volatile memory.

However, this data storage is subject, notably in applications based on smart cards, to various constraints, such as for example the writing time and security.

The writing time is dependent on the type of memory. It is relatively lengthy when the application layer in the card is subject to high time constraints such as, for example, during banking transactions, or in contactless smart cards, etc.

In many cases, the data entrusted to the nonvolatile memory are considered to be sensitive by the application layer. It is therefore important for the process of writing these data to be effected under secure conditions. Any problem found during the writing of these data, such as a writing failure or a fault in or unavailability of functioning of the memory, must be indicated notably to the application layer, which will take the necessary measures, such as cancellation of the transaction, invalidation of the card, etc.

In order to fulfil this writing function, this operating system in the smart card supplies a certain number of services, constituting software entry points, dedicated to the management of the memory, which are hereinafter referred to as the “driver”.

The word “application” designates hereinafter all the software carrying out the application functionalities supported by the card at the application layer thereof. The driver contains subprograms notably for writing and reading data contained in a driver layer.

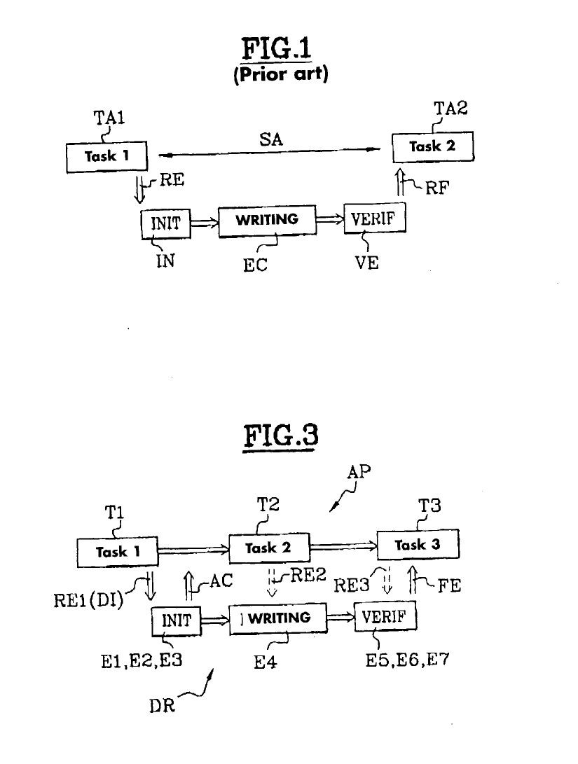

FIG. 1 is a time diagram showing, from left to right, the conventional unfolding of a process of writing in a memory card demanded by the application and executed by the driver. The writing process is generally divided into three steps:

a step of initialisation IN of the controller providing the functionalities of write and read control of the memory, in response to a write request RE of the application;

a write step EC for writing a data item contained in the request RE, whose duration depends on the technical performance of the memory controller;

a verification step VE for verifying the exactitude of the data written in the memory; the verification consists in reading in the memory the data written at the step EC and comparing the data read with the initial data contained in the request RE.

Then the control of the writing process is handed over by the driver to the application by transmitting to it an end response RF after the last verification step VE has ended. Knowing that all the writing process is often relatively lengthy depending on the technology used for manufacturing the memory, the performance of the application is therefore impaired by it. The application is thus suspended until the end of the writing process, as indicated at SA between two successive application tasks TA1 and TA2 in FIG. 1.

In the field of traditional computing, the writing of data “in real time” is a conventional solution which enables data to be written “in non-real time”, that is to say without blocking the running of the application. This solution applies particularly to storage means of the diskette or hard disk type.

On the other hand, writing the data “in non-real time” is much more difficult to implement in the context of an operating system dedicated to a smart card. The operating system must in general adapt to hardware environments which are impoverished in particular in terms of memory of the RAM type. Because of this, it is generally impossible to keep in memory the data to be written with a view to final verification.

The invention aims to adapt to a chip card or to an equivalent portable electronic object the concept of “real-time writing”, without loss of performance with regard to the security of the software.

To this end, a method for writing initial data contained in a write request transmitted by a data processing means to a write/read control means of a memory in a portable electronic object of the smart card type, is characterised in that it comprises the following steps:

transmitting an acknowledgement by the control means to the data processing means immediately in response to the write request only if the control means is available for writing the initial data in the memory,

executing tasks in the data processing means in response to the acknowledgement simultaneously with the writing of the initial data as data written in the memory,

putting the data processing means on standby until the end of the writing if the said means transmits another write request before the end of writing, and

accepting another write request only after the end of the writing of the initial data in the memory by the control means.

Thus the tasks relating to at least one application in the data processing means, such as the processor in the portable electronic object, are executed in parallel with the writing of the initial data in the memory. However, another write request transmitted to the driver in the control means is served only when the writing of the initial data has come to an end. This means that access to the services of the driver is effected through a semaphore controlling the accesses to the process of writing in the driver and capable of managing conflicts between write requests and delaying the expiry of subsequent write requests as long as the driver is not recognised as available.

The release of the driver is signalled to the application developed in the data processing means by an end of writing detection means provided in the portable electronic object in order to count down a predetermined period substantially as soon as the acknowledgement is transmitted and to signal the end of the writing at the expiry of the predetermined period. According to another embodiment, the step of accepting another write request accompanies the deactivation of a voltage increase means internal to the memory.

The control means according to the invention is also capable, in accordance with the security constraints, of providing a check on the integrity of the data to be written, that is to say a verification of the integrity of the initial data compared with the written data occurring between the writing of the initial data and a subsequent reading of the data written under the control of the data processing means. The verification takes place either just after the writing of the initial data, notably before the step of accepting another write request, or after the end of the writing, particularly just before the subsequent reading of the data written.

The invention does not carry out the verification of integrity of the initial data by simple reading of the data written and comparison thereof with the initial data when the resources in the memory of the portable electronic object, such as a smart card, are relatively limited and do not make it possible to temporarily store all the initial data at the time of their writing in memory. The verification of integrity according to the invention can then comprise a comparison of a signature of the initial data with a signature of the written data read. Each signature can be deduced from a cyclic redundancy coding of the corresponding data, or result from a chopping of the corresponding data. The memory occupation for the verification is thus reduced to a data signature appreciably shorter than the data themselves. Knowing that the verification of integrity can be expensive in time for the data processing means, the verification is carried out “in non-real time”, in the form of a minimum priority task, so as not to interfere with sensitive processes, for example the management of a communication protocol at the application layer.

When there is a lack of integrity in the written data compared with the initial data, a security means, such as a security software manager, can be activated, for example, in order to prevent normal usage of the portable electronic object. The execution of the verification thus does not interfere with the current tasks in the application, sometimes uninterruptible, such as the processes related to the communication protocols for example. In order to guarantee this property, the software architecture of the operating system in the data processing means adapts to this constraint by using a veritable simplified real-time kernel capable of arbitrating the priorities allocated to each of the tasks.

Other characteristics and advantages of the present invention will emerge more clearly from a reading of the following description of several preferred embodiments of the invention with reference to the corresponding accompanying drawings, in which:

FIG. 1 is a time diagram of a process of writing in a memory according to the prior art, already commented on;

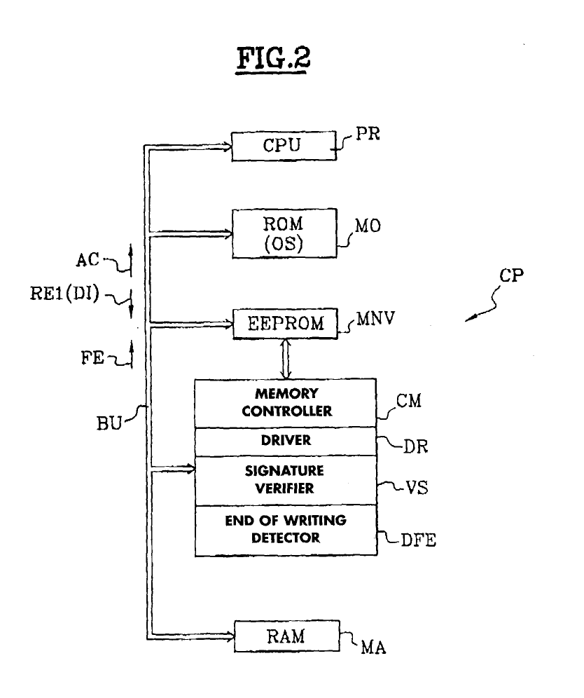

FIG. 2 is a schematic block diagram of the hardware architecture of a smart card;

FIG. 3 is a time diagram of a process of writing in a memory according to the invention;

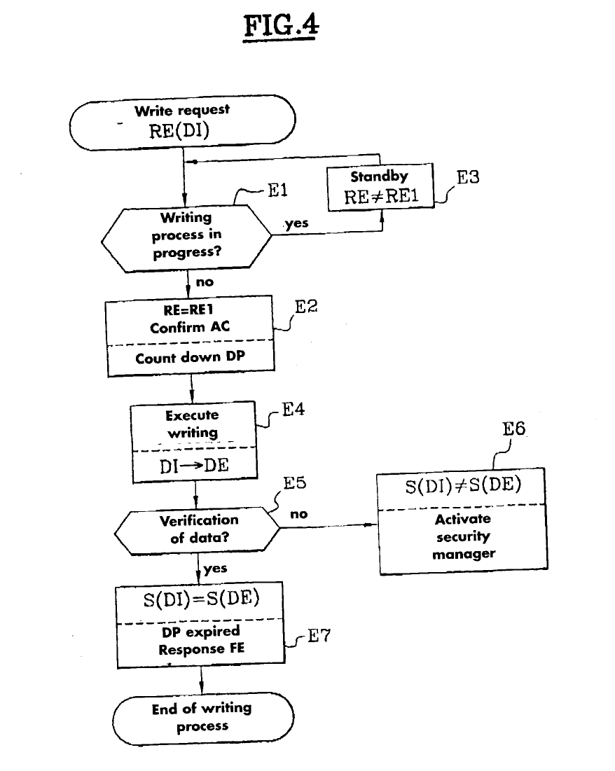

FIG. 4 is an algorithm of a writing process according to a first embodiment of the invention; and

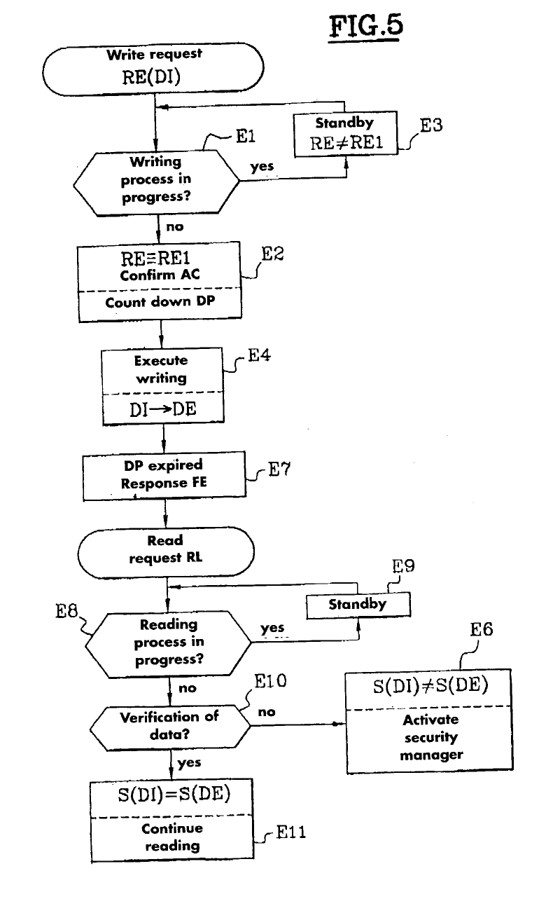

FIG. 5 is an algorithm of a data writing and reading process according to a second embodiment of the invention.

With reference to FIG. 2, a microcontroller constituting the “chip” of a smart card CP, or of any other equivalent portable electronic object, such as a microprocessor module referred to as an SIM (Subscriber Identity Module) smart card which can be inserted in a radiotelephone terminal, contains principally and schematically a central processing unit CPU formed by a microprocessor PR, a memory MO of the ROM type including an operating system OS for the card, possibly supplemented by a browser and specific communication and authentication application algorithms, a non-volatile memory MNV of the EEPROM type which contains data notably relating to the processor of the card, such as a personal identification number and a list of names, and a memory MA of the RAM type intended essentially for processing data to be received from a station accepting the cards, such as a radiotelephone or banking terminal, and to transmit to the accepting station. All the components PR, MO, MNV and MA are connected together by an internal bus BU.

With regard to the invention, the smart card also comprises a controller CM controlling the nonvolatile memory MNV in order to establish commands, such as writing, reading and erasing data in the memory, and for addressing compartments of the memory. The memory controller CM interacts with the processor PR as an application unfolds by exchanging requests and responses through the bus BU. In particular, the controller CM contains or is associated at least partially with a driver DR, controlling at least the process of writing and the process of reading in the memory MNV, with a signature verifier VS and with an end of writing detector DFE. The elements DR, VS and CM are produced in hardware and/or software form; if an element is at least in software form, some of these functionalities can be located in the memory MO.

In FIG. 3 there is a time diagram, comparable with the one according to the prior art in FIG. 1, where an application AP based on the operating system OS runs with successive tasks T1, T2 and T3, from left to right. It is assumed that the application AP establishes, towards the end of the first task T1, a write request RE1 which is then delivered to the driver DR. The application is developed simultaneously with the process of writing in the driver which does not interrupt the application as in FIG. 1 and thus does not block the running of the following tasks T2, T3 following on from the task T1 in the application.

FIG. 4 indicates the main steps E1 to E7 which are encountered following a write request RE established by the application AP according to a first embodiment of the invention.

At the first step E1, the driver initiates a write process relating to initial data DI contained in the request RE, if the driver DR is free of any writing task, as indicated at RE1 in FIG. 3; as already stated, the application AP continues to unfold in parallel to the writing process. The driver confirms the imminent initiation of the writing at the following step E2, by transmitting an acknowledgement AC to the application.

On the other hand, as indicated at step E3, if the write request RE occurs during the writing process, such as the request RE2 towards the middle of the task T2 or the request RE3 towards the start of the task T3 (FIG. 3), the application AP is interrupted until the end of the current writing process, signalled by an end of writing signal FE of the detector DFE; the request RE1 or RE2 is then put on standby by writing it in a queue of the driver which will be read as soon as the current writing process is terminated.

Thus, if at the steps of the process succeeding the initialisation steps E1 and E2, the following task T2 requires no writing, it will be executed without interruption and without being deferred, as according to the prior art. For example, a task T2 in the application AP consisting in sending a response to a station accepting the smart card or receiving a request from the accepting station is not interfered with by the current writing process.

At step E2, simultaneously with the establishment of the response AC, the end of writing detector DFE is activated when, according to a first variant the end of writing detector DFE is not included directly in the controller CM of the memory MNV and is in the form of a timer for a predetermined period DP, that is to say a clock pulse counter. Preprogrammed for a specified predetermined duration of the memory writing, the end of writing detector DFE is activated with the controller CM by the processor PR following the request RE1.

According to a second variant, the end of writing detector DFE is implemented in the controller MC of the non-volatile memory MNV on board the microcircuit. In this example, the stopping of the writing process marked by the reinitialisation of registers and the deactivation of a charge pump increasing a supply voltage to the card as a higher programming voltage internal to a rewritable memory of the EEPROM type, necessary notably for writing, is automatic.

After step E4 following step E2, the driver DR writes the initial data DI contained in the register RE1 in the designated compartment of the memory MNV. The driver next verifies the data written at step E5, which is essential from a security point of view. During step E5, the driver DR reads the written data DE and the verifier VS compares them with the data DI initially contained in the request RE1, before the writing step proper E4. The comparison in the verifier VS is in fact a comparison of a signature S(DI) of the initial data before writing established by the driver and a signature S(DE) of the data read after writing. The signatures S(DI) and S(DE) are calculated in accordance with one and the same verification algorithm; the signature S(DI) of the initial data in the request RE1 is immediately calculated whilst awaiting the calculation of the signature S(DE) of the corresponding written data, and then read in the memory. These signatures advantageously have a length appreciably less than that of the data.

For example, each of the signatures S(DI) and S(DE) is deduced from a cyclic redundancy coding CRC (Cyclic Redundancy Check) carried out very rapidly by the verifier VS without intervention of the processor PR.

According to another example, each of the signatures S(DI) and S(DE) results from a chopping of the corresponding data, that is to say results from a sampling of predetermined parts of the corresponding data, and the signatures resulting from the chopped initial data and the data written and then read and chopped are compared.

The verifier VS can be implanted in hard-wired logic, as shown in FIG. 2, or implemented in software form in the ROM memory MO.

If the verification test reveals a lack of integrity in the written data DE compared with the initial data DI at step E5, a security means, for example a security manager implemented in the memory MO of the smart card, is activated, as indicated at step E6, in order to execute an emergency task. The emergency task consists for example in inhibiting any communication between the smart card CP and the card-accepting station in which the card has been inserted and thus to invalidate the card, or to demand the rewriting of the initial data, for example by interrupting the application AP, or transferring the process of writing initial data in the driver to another memory of the card.

The end of the process of writing with verification is noted at step E7 by the end of writing detector DFE, which indicates it to the controller CM after the end of the previous writing process. The controller is then in a state to accept another write request, possibly already waiting, like the request RE2 shown in FIG. 3.

As a variant, the controller CM generates an end of writing signal FE in the form of an interrupt transmitted to the application AP. When the detector DFE is the aforementioned duration timer, the passage to zero thereof corresponding to the expiry of the predetermined period DP is indicated by the signal FE to the processor PR, which stops the controller CM. When the detector DFE is implemented directly in the controller CM, the latter automatically generates the signal FE in order to deliver it to the processor PR after a predetermined delay following on from the deactivation of the charge pump necessary for writing, the said delay being available for verification.

According to another embodiment, the verification step E5 with the security step E6 is included not in the process of writing between steps E4 and E7, but at the start of the subsequent process of reading the data written in the memory MNV by the processor PR, as shown at E10 in FIG. 5. Step E10 follows a read request RL from the application AP, applied by the processor PR to the driver DR through the bus BU. The read request RL is validated by the driver DR at a step E8 for reading, in a similar manner to step E1, or is put on standby until the end of a reading process during a step E9, when the driver DR processes a write request.

Then, after the positive verification at step E10, the reading process is continued in a known manner at a step E11.

1. A method for writing initial data contained in a write request (REl) transmitted by a data processing means (PR, AP) to a write/read control means (CM, DR) of a memory (MNV) in a portable electronic object (CP), characterised in that it comprises the following steps:
transmitting (E1, E2) an acknowledgement (AC) by the control means (CM, DR) to the data processing means (PR, AP) immediately in response to the write request (REl) only if the control means is available for writing (E4) the initial data (DI) in the memory,
executing tasks (T2, T3) in the data processing means in response to the acknowledgement simultaneously with the writing (E4) of the initial data (DI) as data written (DE) in the memory,
putting (E3) the data processing means (PR, AP) on standby until the end of the writing if the said means transmits another write request (RE2) before the end of writing, and
accepting (E7) another write request (RE2) only after the end of the writing of the initial data in the memory (MNV) by the control means.

2. A method according to claim 1, according to which an end of writing detection means (DFE) is provided in the portable electronic object (CP) in order to time a predetermined period (DP) substantially as soon as the acknowledgement (AC) is transmitted (E2) and to indicate the end of writing (E7) at the expiry of the predetermined period.

3. A method according to claim 1, in which the step (E7) of accepting another write request accompanies the deactivation of a voltage increase means internal to the memory (MNV).

4. A method according to any one of claims 1 to 3, comprising a verification (E5, E10) of the integrity of the initial data (DI) compared with the written data (DE) occurring between the writing of the initial data (E4) and a subsequent reading (E11 of the written data (DE).

5. A method according to claim 4, according to which the verification (ES) occurs just after the writing (E4) of the initial data (DI).

6. A method according to claim 4, according to which the verification (E10) occurs just before the subsequent reading (E11) of the data written (DE).

7. A method according to any one of claims 4 to 6, according to which the verification comprises a comparison of a signature (S(DI)) of the initial data with a signature (S(DE)) of the written data read in the memory (MNV).

8. A method according to claim 7, according to which each signature is deduced from a cyclic redundancy coding of the corresponding data.

9. A method according to claim 7, according to which each signature results from a chopping of the corresponding data.

10. A method according to any one of claims 4 to 9, comprising the activation of a security means (E6) in response to a lack of integrity in the written data (DE) compared with the initial data (DI).
